(19) United States
(12) Patent Application Publication
(10) Pub. No.: US 2024/0323758 A1
(43) Pub. Date: Sep. 26, 2024

(54) Fronthaul Automation and Intelligent Traffic Distribution for Fronthaul Multiplexer

(71) Applicant: DZS Inc., Plano, TX (US)

(72) Inventor: Andrew Stuart Gibbs, Andover, MA (US)

(21) Appl. No.: 18/317,552

(22) Filed: May 15, 2023

Related U.S. Application Data
(60) Provisional application No. 63/491,599, filed on Mar. 22, 2023.

(51) Int. Cl. H04W 28/06; H04W 28/08; H04W 28/082

(52) U.S. Cl. CPC H04W 28/06; H04W 28/082; H04W 28/0983

(57) ABSTRACT

A radio network may include: a distributed unit (DU); a fronthaul multiplexer coupled to the distributed unit; a plurality of RUs, each one of the RUs being in communication with the DU through the fronthaul multiplexer; and a control loop (either open or closed) configured to detect performance parameters of the plurality of RUs, to train an artificial intelligence (AI) or machine learning (ML) application using the performance parameters, and wherein the AI or ML application is configured to, once trained, receive either the performance parameters or analysis of the performance parameters and to adjust a multiplexing functionality of the fronthaul multiplexer during use of the radio network and in near real time based on either the performance parameters or the analysis of the performance parameters.

### CROSS-REFERENCE TO RELATED APPLICATIONS

The present application claims the benefit of U.S. Provisional Patent Application No. 63/491,599, filed Mar. 22, 2023, and entitled “Intelligent Load Balancing And Fronthaul Automation For Fronthaul Multiplexor,” the disclosure of which is incorporated by reference herein in its entirety.

### TECHNICAL FIELD

Various embodiments are directed toward fronthaul multiplexing in a telecommunications system and, more specifically, toward techniques for dynamically adjusting fronthaul multiplexing.

### BACKGROUND

Fifth Generation (5G) networks have been designed to enable faster and more reliable mobile connectivity, with a greater capacity to support a wide range of applications and services. One example feature of 5G networks includes the use of an architecture in which the RUs (RUs) are located closer to the end-users, while the Baseband Processing Units (BBUs) are centralized. The RUs and BBUs are connected via a high-speed, low-latency fronthaul connection. The fronthaul connection allows for the transmission of large amounts of data and control signals between the RUs and BBUs, enabling the network to deliver high-bandwidth, low-latency services.

### BRIEF SUMMARY OF SOME EXAMPLES

According to one implementation, a radio network may include: a distributed unit (DU); a fronthaul multiplexer coupled to the distributed unit; a plurality of RUs, each one of the RUs being in communication with the DU through the fronthaul multiplexer; and a control loop configured to detect performance parameters of the plurality of RUs, including a Service and Management Orchestrator (SMO), which is configured to receive either the performance parameters or analysis of the performance parameters and to adjust a multiplexing functionality of the fronthaul multiplexer during use of the radio network and in near real time based, at least in part, on either the performance parameters or the analysis of the performance parameters.

According to another implementation, a method includes using a feedback loop to control performance of a Radio Access Network (RAN), the method including: gathering experience data at an outer loop control component that is upstream from a baseband unit, wherein the experience data relates to performance parameters of the RAN; analyzing the experience and traffic behavioral data; and sending control signals to a fronthaul multiplexer, wherein the control signals are configured to adjust one or more multiplexing groups during use of the RAN and in near real time based, at least in part, on analyzing the experience and traffic behavioral data.

According to another implementation, a non-transitory computer readable medium includes computer-executable code, which when executed by one or more computer processors, causes the one or more computer processors to perform a method of using a feedback loop to control performance of a Radio Access Network (RAN), wherein the computer readable medium includes: code for gathering experience data and data on traffic patterns at a component that is upstream from a baseband unit, wherein the data relates to performance parameters of the RAN; code for analyzing the data; and code for sending control signals to a fronthaul multiplexer, wherein the control signals are configured to adjust one or more multiplexing groups during use of the RAN and in near real time based, at least in part, on analyzing the network heuristics data.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various implementations and to explain various principles and advantages in accordance with the present disclosure.

FIG. 1 is an illustration of example scenarios of fronthaul communications in a telecommunications network, according to various implementations of the present disclosure.

FIG. 2 is an illustration of an example architecture for fronthaul communications in a telecommunications network, according to various implementations of the present disclosure.

FIG. 3 is an illustration of example fronthaul communications between a distributed unit and multiple RUs without the use of a fronthaul gateway, according to various implementations of the present disclosure.

FIG. 4 is an illustration of example fronthaul communications between a distributed unit and multiple RUs, including the use of a fronthaul gateway, according to various implementations of the present disclosure.

FIG. 5 is an illustration of example fronthaul communications between a distributed unit and multiple RUs, including the use of a fronthaul gateway with multiplexing functionality, according to various implementations of the present disclosure.

FIG. 6 is an illustration of example fronthaul communications between a distributed unit and multiple RUs, including the use of a fronthaul gateway with multiplexing functionality and a feedback loop to control and adjust the multiplexing functionality, according to various implementations of the present disclosure.

FIG. 7 is an illustration of an example method, which may be performed by the technology of FIGS. 2 and 6, according to various implementations.

### DESCRIPTION

Various implementations include methods, systems, and computer program products for providing intelligent traffic distribution and automation for a fronthaul multiplexer. For instance, an outer control feedback loop may be implemented within a telecommunication network, where the feedback loop gathers experience and traffic behavioral feedback and uses that continuous feedback and decision analysis to adjust a fronthaul multiplexer to accommodate current or expected conditions. The ML-Ops data model may provide open loop operator supervision or closed loop behaviors to optimize network performance. In one example, the feedback loop gathers traffic behavioral feedback (e.g., data regarding packet drops, throughput, jitter, and the like) to determine whether and how to adjust the fronthaul multiplexer.

An example fronthaul multiplexer may group multiple RUs into a single cell, may group multiple RUs into multiple cells, may configure some or all single RUs as single cells, and the like. For example, out of four RUs, the fronthaul multiplexer may group all four RUs into a single cell, may group two of the RUs into a first cell and two of the RUs into a second cell, may group three of the RUs into a first cell and one of the RUs into a second cell, or may treat each of the RUs as its own individual cell.

Grouping multiple RUs into a cell may reduce an amount of control signaling, such as may be associated with handoffs and mobility events, employed to operate the multiple RUs. So grouping RUs into a cell may create statistical multiplexing gains, especially with respect to control signaling and reduced power management. However, as bandwidth use increases at a single cell, the cell may experience packet drops or delay, which may indicate that multiple cells, instead of just one, should be used. In other words, multiplexer settings may be used to balance performance and efficiency.

Dynamically adjusting the fronthaul multiplexer may include using control signals to change the fronthaul multiplexer from one setting to another setting during use of the telecommunications network. In one working example, a multitude of low-bandwidth user elements (UEs) may be serviced by a multitude of RUs that are grouped into a single cell. Therefore, the user data and control signals associated with the low-bandwidth UEs may be combined by the multiplexer and transmitted in the fronthaul communications to a baseband unit. However, as the bandwidth between the UEs and the RUs increases, it may be beneficial to use multiple cells instead of a single cell. For example, if a bandwidth-heavy user comes online in addition to the multitude of low-bandwidth UEs, some efficiency and performance may be gained by serving the bandwidth-heavy user through cell splitting, in order to separate the traffic of the low and high-bandwidth UEs.

Of course, over a duration of time, bandwidth utilization and other conditions may change, and those changing conditions may benefit from changing multiplexer settings. Thus, various implementations herein propose to adjust multiplexer settings, as appropriate for given conditions, and based at least in part on traffic behavior and performance telemetry within a feedback loop. Or put another way, various implementations may provide dynamic adjustment of the signal domain by changing one or more multiplexing groups.

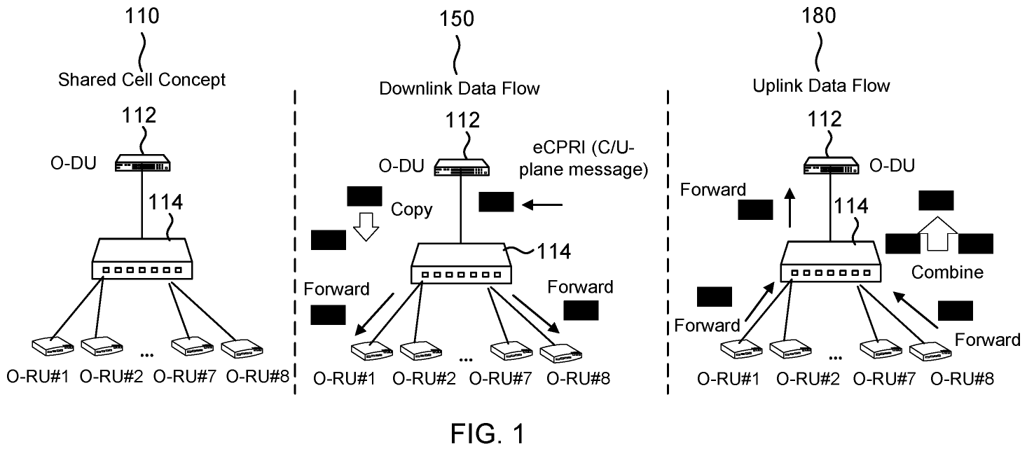

FIG. 1 illustrates example scenarios 110, 150, 180 of fronthaul communication in a network, such as a 5th generation (5G) network. Fronthaul communications in a telecommunications network refers to the high-speed connection between the radio access network (RAN) and the Baseband Processing Unit (BBU) of a base station (e.g., gNB). The fronthaul connection enables the transfer of data and control signals between the RAN and BBU, which enables high-performance and low latency 5G services. Additionally, the fronthaul communications provides timing and synchronization for the RAN and Layer 1/Layer 2 (L1/L2) portions of the BBU. In the present example, the RA is represented by multiple RUs (RUs) 1-8, and the BBU may be included as a function of the Distributed Unit (DU) 112.

The BBU may be responsible for processing and managing the wireless signals transmitted and received by the RUs. The BBU performs a wide range of tasks, including baseband processing, modulation, demodulation, coding, and decoding of the wireless signals.

The fronthaul connection couples multiple RUs located at the cell sites to the Distributed Unit (DU) and Central Unit 112. In the present example, the DU 112 is an O-RAN DU, where the concept of O-RAN is discussed in more detail below. In this example, the DU 112 includes at least one BBU and also provides control signaling to the RUs 1-8, via the fronthaul connection, to facilitate digital signal processing, beamforming and the like. The fronthaul connection carries a stream of control signals and baseband data, including digitized voice, video, and other data traffic, which is processed in real-time by the BBU to provide network functions.

The fronthaul connection enables 5G network features such as massive MIMO (Multiple Input Multiple Output), forward error correction, channel estimation, and beamforming, which requires the synchronization and timing of the digital signals to the attached radios and the real-time transfer of large amounts of data between the RUs and DU. The most common fronthaul protocols used in 5G networks are the Common Public Radio Interface (CPRI) and the Enhanced CPRI (eCPRI), which provide high-speed connectivity and support for various network functions.

The shared cell concept 110 of FIG. 1 includes eight O-RAN RUs 1-8, a fronthaul multiplexer 114 (labeled “FHM”) and a DU 112. Of course, eight RUs is just an example, and the scope of implementations may be scaled to any appropriate number. Furthermore, the fronthaul multiplexer 114 includes fronthaul multiplexer functionality, which may be implemented as firmware on a field programmable gate array (FPGA) or implemented in another appropriate way. In this example, the fronthaul multiplexer 114 abstracts the RUs 1-8 into a single cell. As a result, the DU 112 sees a single stream to and from the fronthaul multiplexer 114. In the uplink dataflow 180, the fronthaul multiplexer 114 receives CPRI IQ control signals from each of the RUs and combines the control signaling and the data into a single aggregated data stream. Combining may include, e.g., summing signals from the multiple RUs. In the downlink dataflow 150, the fronthaul multiplexer 114 receives aggregated data from the DU, copies the control signaling and the data for each of the individual RUs, and forwards the copied data and control signaling to the individual RUs. In a sense, the RUs simulcast on the downlink.

The examples shown in FIG. 1 may be implemented within an O-RAN (Open Radio Access Network) architecture. O-RAN is an architecture for wireless communication networks that enables multi-vendor interoperability and innovation. It includes a software-based disaggregated solution where the Layer 2/Layer 3 (L2/L3) baseband processing functions are separated from the radio/antennas and run on general purpose hardware and processors. It is a concept that enables different vendors to develop and integrate their RAN components, including radios, antennas, and baseband units, into a single, cohesive network.

In an O-RAN architecture, the fronthaul multiplexer 114 is an interface between the multiple RUs and the DU 112. The fronthaul multiplexer 114 is responsible for aggregating and transporting the traffic from the RUs to the DU 112 over the high-speed fronthaul network. It is also responsible for providing deterministic, low latency timing and synchronization to these elements.

The fronthaul multiplexer 114 may be combined with a gateway, where the gateway ensures the efficient and reliable fronthaul transfer of data between the RUs and midhaul data transfer to the DU 112, while also providing protocol conversion, security, and synchronization services. Some of the roles of a fronthaul gateway in an O-RAN system are:

Aggregation: A fronthaul gateway aggregates the data from multiple RUs into a single data stream that can be transmitted over the fronthaul network to the DU 112. Aggregation may help to reduce the number of network connections seen at the DU 112 and to improve the efficiency of the fronthaul network. Additionally, a fronthaul gateway has the potential to reduce power consumption by sending a single vs separate signals to the downstream RUs.

Protocol conversion: A fronthaul gateway performs protocol conversion between the different RAN interfaces used by the RUs and the DU 112. Protocol conversion may enable the RUs to use different vendor-specific interfaces and protocols while still communicating with the DU 112, which promotes interoperability and allows for a more flexible and open architecture.

Synchronization: A fronthaul gateway provides IEEE 1588 Precision Time Protocol (PTP) and ITU-T Synchronous Ethernet (SyncE) timing and synchronization signals to the RUs and the DU 112 to ensure that they are operating in sync and that the data is transmitted at the correct time.

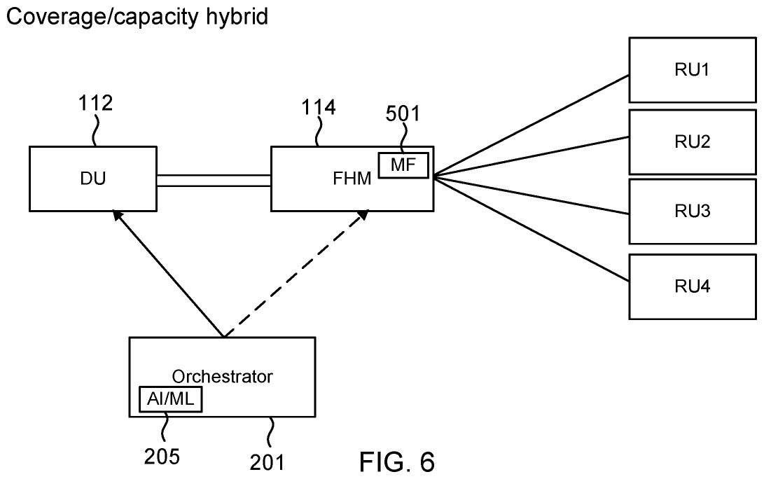

As explained in more detail below, various embodiments may include methods to turn on or turn off multiplexing and to form multiplexing groups dynamically with respect to all RUs or just a subset of RUs during use. An example of multiplexing groups includes a multiplexing group A for RU1 and RU2, multiplexing group B for RU3 and RU4, as in the description of FIG. 6. Some advantages may include flexibly adapting to low bandwidth and high-bandwidth loads as needed, while using DU resources more efficiently.

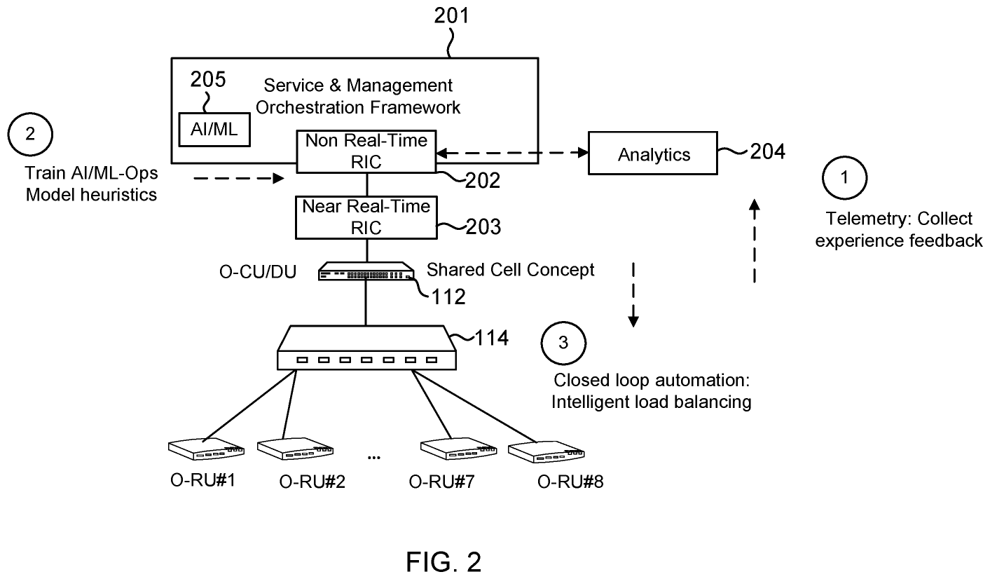

FIG. 2 is an illustration of fronthaul multiplexing, according to some embodiments. FIG. 2 adds a Service and Management Orchestrator (SMO) 201, a Non-Real-time RAN intelligent controller (RIC) 202, a Near Real-Time RIC 203, and a closed loop control system providing automation and intelligent traffic distribution at the fronthaul multiplexer 114.

The SMO 201 is a component of the O-RAN architecture. It is a software system that provides centralized management and orchestration of RAN resources across multiple vendors, and layers. The SMO 201 enables network operators to manage, configure, and optimize the RAN infrastructure, including cell site configurations, frequency allocations, and resource utilization.

The SMO 201 provides a standardized interface and communication protocol between RAN components and, thus, the SMO 201 enables different vendors to interoperate, reducing the complexity and cost of integrating disparate systems.

A RAN Intelligent Controller (RIC) is a network element that provides advanced control and management capabilities to improve network performance and user experience. There are two types of RICs in a 5G network: Non-Real-Time RIC 202 and the Near Real-Time RIC 203.

The Non-Real-Time RIC 202 collects network data, performs analysis, and provides recommendations to optimize network performance. It may collect data that is used by consumers that are external to the radio domain. The typical processing response time may be 1-10 seconds. The Non-Real-Time RIC 202 is responsible for creating network policies that determine how resources are allocated across the network, such as which cells are activated or deactivated, which frequency bands are used, and how much power is allocated to each RU. The Non-Real-Time RIC 202 can also adjust network efficiency by identifying areas of the network that are underutilized and reallocating resources to better serve high-traffic areas. For example, using its ML-Ops trained data model for the fronthaul automation service, the Non-Real-Time RIC may exercise closed loop optimization to change the fronthaul multiplexer configuration at regular intervals such as on a daily basis.

On the other hand, the Near Real-Time RIC 203 is responsible for more real-time decision-making in the network. The typical processing response time may be within the range of 1-10 milliseconds. It receives data from the network and performs analysis in near real-time to make decisions about resource allocation. The Near Real-Time RIC 203 may quickly respond to network events, such as congestion or interference, to improve network performance and user experience. The Near Real-Time RIC 203 may also provide network intelligence to third-party applications, such as network analytics or network security applications, to improve their performance and effectiveness.

FIG. 2 shows a control feedback loop that collects analytics, such as experience or usage information. Examples of experience or usage information may include the usage of an individual RU, such as in a metric like throughput, jitter delay, packet drops, availability, and the like. In the example of FIG. 2, the SMO 201 communicates with an analytics module 204, which collects the data, performs algorithmic decision analysis and triggers applied actions.

The analytics module 204 may include a software module that is part of, or separate from, the SMO 201. In this example, the analytics module 204 may also be used to train an artificial intelligence (AI) or machine learning (ML) application 205 that is associated with the Non-Real-Time RIC 202. The AI or ML application 205 may be included within the Non-Real-Time RIC 202, within the SMO 201, or as a standalone module. Once the AI or ML application 205 is trained, it may be used to dynamically adjust traffic distribution across the RUs by triggering programmatic changes to the fronthaul multiplexer 114. For instance, the AI or ML application 205 may cause the multiplexing functionality at the fronthaul multiplexer 114 to treat all of the RUs as a single cell, to divide the group of RUs into multiple different cells, to include or exclude a given RU from one or more other cells, and the like. In other words, the AI or ML application 205 may cause the multiplexing functionality to perform a radio unit-by-radio unit inclusion or exclusion from grouping into cells. The AI or ML application 205 may affect the multiplexing functionality at the fronthaul multiplexer 114 by sending control signals from the Non-Real-Time RIC 202 to the Near Real-Time RIC 203, which sends the same or different control signals to the fronthaul multiplexer 114 to implement the change.

The trained AI or ML application 205 may have different usage thresholds to cause one or more of the RUs to be combined with other RUs or to be carved out from a larger cell to be treated on its own. For instance, if one of the RUs happened to be overly congested, the AI or ML application 205 may program the fronthaul multiplexer 114 to redistribute the traffic across the uncongested radios within the group. In another example, the trained AI or ML application 205 may divide the RUs into cells on a per-slice or per-service basis.

A slice refers to a logical division of physical and software resources into a virtual network. For instance, one or more RUs, CU/DU resources, transport resources, and core network resources may be allocated to a virtual network to serve a particular customer or group of customers. Examples of slices include high-bandwidth slices, enhanced mobile broadband slices, ultra-reliable low latency slices, mission-critical slices, and the like.

When setting up a slice, a network operator may instruct the SMO 201 in the radio domain to provide a particular kind of service to a particular subscriber or group of subscribers at a particular location with a specified amount of bandwidth and availability. The SMO 201 may then set up a virtual network accordingly. The SMO 201 processes the instructions and runs application programming interface (API) calls to the CU and DU in the RAN to program the request.

One working example includes a factory floor at which the RUs of FIG. 2 are implemented. The RUs service a multitude of low-bandwidth sensors as well as a multitude of more bandwidth-intensive applications, such as factory floor robotics, vision systems, and the like. Further in the example, the low-bandwidth sensors may be in use less constantly, whereas the factory floor robotics and vision systems may be in on a more frequent basis.

The SMO 201 may combine all of the RUs into a single super cell in response to a time period in which usage is dominated by the low-bandwidth sensors. As a result, the low bandwidth use from the sensors is combined by the fronthaul multiplexer 114 into an amount of data and control signals that maximized the statistical multiplexing gain of DU resources. However, as more bandwidth-heavy users join the network, the system may experience higher levels of packet drops, delays, or call failures, thereby indicating that the super cell is overutilized. The AI or ML application 205 reviews either the traffic performance feedback directly or via an interconnected external analytics module 204. Based on the experience feedback from the analytics module 204, the AI or ML application 205 recognizes the overutilization scenario and, according to its logic, adjusts the operation of the fronthaul multiplexer 114. Adjusting the operation of the fronthaul multiplexer 114 may include sending control signals to the Near Real-Time RIC to cause the fronthaul multiplexer 114 to adjust multiplexing groups by logically splitting off one or more of the RUs from the super cell into one or more new cells to service the bandwidth heavy usage. The DU 112 may also be scaled to include another instance of DU functionality, thereby making more than one DU instance to service the factory floor. As a result, the radio resources and DU resources are appropriately scaled and used for the increased bandwidth.

Subsequently, as the high-bandwidth usage application may drop off, the AI or ML application 205 may recognize underutilization through either the experience feedback or analytics from the analytics module 204 and may logically move one or more RUs back to the super cell and, perhaps, scale down the number of DU instances. The AI or ML application 205 may continue to operate as such through increases and decreases of aggregate data usage levels to perform more efficient traffic distribution across the RAN. Furthermore, the AI or ML application 205 may be trained from time to time to recognize different scenarios and to dynamically load balance the RAN appropriately by adjusting multiplexing groups.

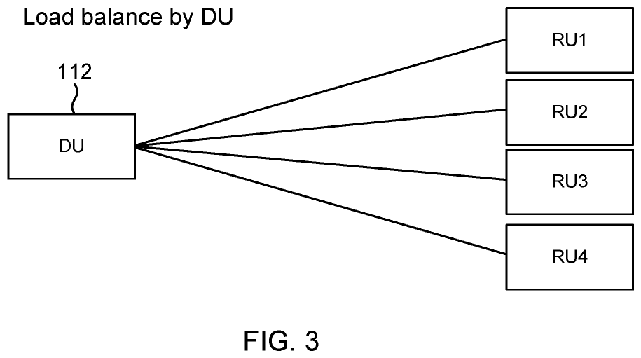

FIG. 3 is a view of fronthaul connections between a DU 112 and multiple RUs, according to one implementation. Note that in FIG. 3, the system does not include the closed-loop feedback system to perform dynamic load-balancing, as in FIG. 2.

In FIG. 3, the DU 112 has full logical connections with each of the RUs. There are multiple RUs, and some of the RUs may be combined so that two or more combined RUs may transmit and receive the data and control signals, whereas other RUs may transmit and receive different data and control signals. In this example, the control signaling is fully under control of the DU 112, and RU 1 and RU 2 are logically grouped into a cell, and RU 3 and RU 4 are logically grouped into another cell. The demand on the DU 112 is proportional to the number of RUs. In this example, the DU 112 may be overloaded in part due to data traffic and in part due to the responsibility of controlling the RUs.

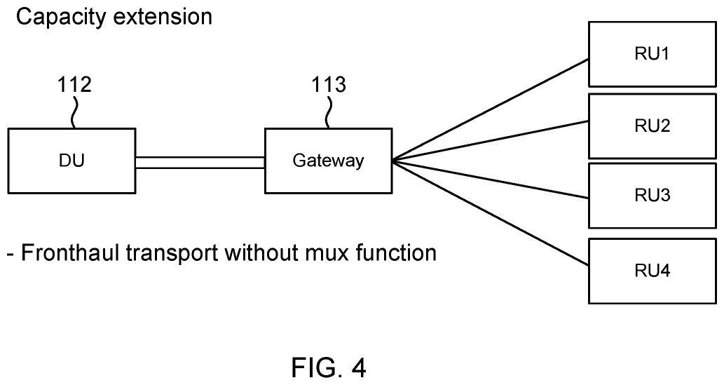

FIG. 4 is a view of fronthaul connections between a DU 112 and multiple RUs, via a fronthaul gateway 113, according to one implementation. In FIG. 4, the fronthaul gateway 113 does not include a multiplexing functionality (e.g., as in FIG. 2). Each of the different RUs is used as a different cell, so there is no logical grouping among any of the cells. There may be a fiber connection between the fronthaul gateway 113 and the DU 112 to carry the data and control signaling. In this example, the workload on the DU 112 is roughly the same as it is in the example of FIG. 3, even though fronthaul gateway 113 has been placed between the DU 112 and the RUs. The workload on the DU 112 may be higher than optimal.

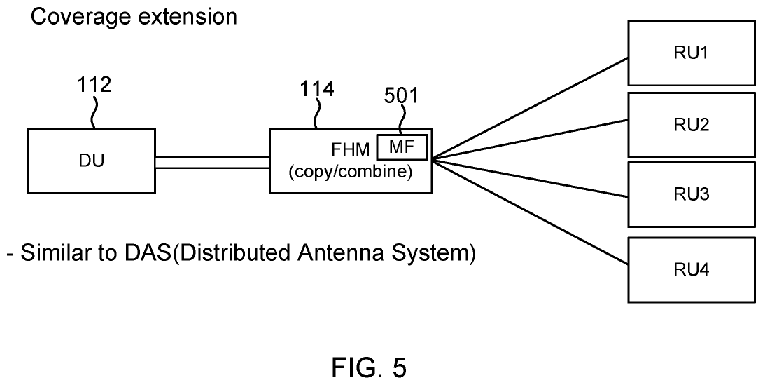

FIG. 5 is a view of fronthaul connections between the DU 112 and multiple RUs, via a fronthaul multiplexer 114 having multiplexing functionality 501, according to one implementation. In FIG. 5, the RUs 1-4 are combined into a shared cell. The multiplexing functionality 501 includes a “copy” function for the downlink and a “combine” function for the uplink, as in FIG. 1. The multiplexing functionality 501 may be implemented as hardware logic, firmware, or software configured to perform the copy and combine actions discussed above.

FIG. 6 is a view of fronthaul connections between the DU 112 and multiple RUs, via the fronthaul multiplexer 114. Furthermore, the fronthaul multiplexer 114 includes multiplexing functionality 501, and the orchestrator may perform functions the same as or similar to the functions described above for the SMO 201 with respect to FIG. 2.

The fronthaul multiplexer 114 has knowledge about the signal domain, and it is controlled by the SMO 201 and DU 112. In this example, RU 1 and RU 2 are combined into a cell, and RU 3 and RU 4 combined into a different cell. Thus, there are two different multiplexing groups, each corresponding to a different cell. The fronthaul multiplexer 114 performs the “copy” and “combine” functions, by virtue of multiplexing functionality 501, for each of the two cells separately.

As a result, the DU 112 only sees two sets of signals (one signal set for each cell). Thus, the power demand on the DU 112 is less than having full control over four RUs. When the power use of the DU 112 is reduced and the number of signals controlled by the DU 112 is reduced, that may reduce power cost and licensing cost of the DU 112.

The SMO 201 may include an AI or ML application 205 and may be part of a closed-loop feedback system, as in FIG. 2. Such structure may allow the system of FIG. 6 to provide more efficient traffic distribution, as explained above with respect to FIG. 2. Further in this example, the SMO 201 control over the fronthaul multiplexer 114 may allow dynamic multiplexing on a RU-by-RU basis, thereby providing beneficial flexibility that can change with load and service.

The technology of FIGS. 2 and 6 represents an enhancement to fronthaul multiplexer design for inbuilding mobile private networks. The technology of FIGS. 2 and 6 may be employed in a fronthaul automation use case that enables the operator to selectively enable or disable the multiplexing functionality 501 on a slice- and service-specific basis. Customers can enable the multiplexing functionality 501 for coverage-based slices such as industrial automation where are there are many low data sensor devices that intermittently send/receive data. For a capacity oriented slice/service like high bandwidth video processing, the multiplexing can be selectively disabled on an individual radio unit basis in a fronthaul group. The technology of FIGS. 2 and 6 may include an AI or ML application 205 in which case it is possible to consume non real-time telemetry (e.g., experience management) and to train an ML-Ops model as an rApp on a Non-Real-time RIC 202 application that interworks with an SMO 201 for a radio domain. Using threshold-based triggers or alarms, the SMO 201 and the Non-Real-Time RIC 202 can dynamically program the Near-Real Time RIC 203 to intelligently adjust the traffic mix to redistribute the aggregate traffic load across the other RUs in the fronthaul multiplexer group.

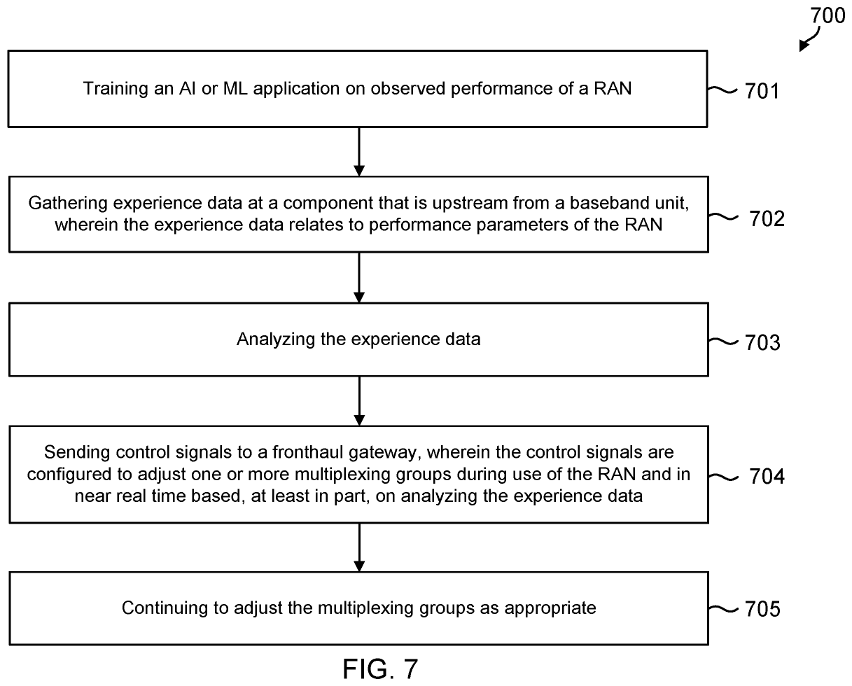

FIG. 7 is an illustration of an example method 700, which may be performed by the technology of FIGS. 2 and 6, according to various implementations. In more detail, the method 700 may be performed by one or more processors, executing computer code, to provide the functionality of method 700. Furthermore, the actions of method 700 may be performed by applications running on bare-metal, applications running on one or more guest operating systems in a virtual environment, or in any other appropriate architecture.

Action 701 includes training an AI or ML application 205 on observed performance of a RAN. As an example, in FIG. 2, the analytics module 204 is located downstream from the BBU, which is included within the DU 112. The analytics module 204 may collect data about performance of the network over a period of time, during different usage states and during use of different multiplexer settings. The collected data may then be used as a training data set for the AI or ML application 205, which may be included within or be separate from a Non-Real-Time RIC 202. The training has as a goal balancing performance and efficiency of the telecommunications network of FIG. 2. For instance, the training process may teach the AI or ML application 205 to group individual RUs into a cell or at least reduce a number of cells by grouping RUs at times when bandwidth use by UEs is low. For instance, the training process may teach the AI or ML application 205 to increase efficiency of control signaling to the RUs during times when control signaling efficiency is possible. The training process may also teach the AI or ML application 205 to increase a number of cells to service higher bandwidth applications when appropriate. For instance, the training process may teach the AI or ML application 205 to split off one or more RUs from a cell and use those one or more RUs to service the higher bandwidth application when possible.

The scope of implementations is not limited to any particular AI or ML application 205. Furthermore, other implementations may omit use of an AI or ML application 205 for automation of fronthaul multiplexer functionality. Instead, some implementations may use more traditional reactive rules-based programming to set thresholds that correspond to network parameters and different multiplexer settings. The SMO 201 may determine the adjustment based on the AI or ML application 205, but the AI or ML application 205 is not the only possible decision mechanism within the scope of implementations. For instance, manual configuration by human learning or administrative rules-based policy may be used to perform the dynamic adjustment of the signal domain instead of, or in addition to, the AI or ML application 205.

Action 702 includes gathering experience data at a component that is upstream from a BBU. The experience data relates to performance parameters of the RAN. An example of a component that is upstream from the BBU includes an analytics module 204, such as is illustrated in FIG. 2. Another example includes any appropriate component in the SMO 201 or in the digital and baseband domain of the telecommunications network, where that component has access to the experience data. The experience data may be gathered from probes (not shown) distributed within the telecommunications network. Examples of experience data include, e.g., packet drops, jitter delay, radio unit availability, unsuccessful calls, and throughput, multiplexing state, and the like.

Action 703 includes analyzing the experience data. The experience data may be analyzed by the AI or ML application 205. In other implementations, the experience data may be analyzed by an application created by traditional programming. Analyzing the experience data may include parsing the experience data and determining actions to take based at least in part on the contents of the experience data.

Action 704 includes sending control signals to a fronthaul multiplexer 114 based at least in part on the analysis from action 703. For instance, the AI or ML application 205 may cause a Near Real-Time RIC 203 to adjust a multiplexing functionality 501 of the fronthaul multiplexer 114 during use of the RAN. Action 704 may include the AI or ML application 205 sending a first set of control signals to the Near Real-Time RIC 203, and the Near Real-Time RIC 203 sending a second set of control signals to adjust one or more multiplexing groups. In another implementation, the AI or ML application 205 may send control signals directly to the fronthaul multiplexer 114. In yet another implementation, an application created by traditional programming and running at the SMO 201 may send control signals, either directly or indirectly, to the fronthaul multiplexer 114 to adjust the multiplexing functionality 501. In another implementation, a human user may manually adjust the multiplexing functionality 501. In any event, action 704 results in the multiplexing functionality 501 of the fronthaul gateway being adjusted in near real-time and in response to the analysis of action 703.

As noted above, the multiplexing groups may be adjusted on a per-RU basis, on a per-slice basis, and on a per-service basis. Furthermore, action 704 may include the AI or ML application 205 or the SMO 201 instructing the near real-time RIC to steer traffic to a radio that supports a specific type of spectrum. This may be referred to as “band or frequency steering”. For example, the fronthaul multiplexer 114 and multiplexing functionality 501 may be instructed to steer traffic to a RU or cell that supports coverage-based spectrum when the traffic is mostly from low-bandwidth UEs. An example of an RU having a coverage-based spectrum includes a sub-6 GHZ radio supporting C-band spectrum in the N78 3.5 Ghz range. In other words, the fronthaul multiplexer 114 and multiplexing functionality 501 may be instructed to steer low-bandwidth traffic to an RU or a cell of multiple RUs that support a coverage-based spectrum.

Meanwhile, the AI or ML application 205 or SMO 201 may steer bandwidth-intensive video processing applications to one or more RUs or cells that support capacity-based frequencies. An example of an RU supporting a capacity-based spectrum includes an FR2 millimeter-based radio such an N257 28 GHz radio. In other words, the fronthaul multiplexer 114 and multiplexing functionality 501 may be instructed to steer higher-bandwidth traffic to an RU or a cell of multiple RUs that support high-bandwidth capacity-based spectrum.

Migrating an RU into or out of a particular multiplexing group in action 704 may be performed in any appropriate manner. For instance, an RU that is migrated out of a multiplexing group may be caused to gradually reduce its power, while allowing any UEs served by that RU to adapt. Once one or more UEs have switched to be served by other RUs in that multiplexing group, that particular RU may then be caused to join the different multiplexing group. Similarly, once the particular RU has joined the different multiplexing group, it may have its power gradually increased to allow the UEs in the different multiplexing group to adapt. In another instance, the RU that is migrated out of the multiplexing group and into the different multiplexing group may have an abrupt switch from the one multiplexing group to the other.

Action 705 includes continuing to adjust the multiplexing groups as appropriate. For instance, as the RAN operates, the parameters may have different values, and those different values may be gathered at action 702, analyzed at action 703, and result in a change to the multiplexing functionality settings at action 704.

Some examples of processing systems described herein may include non-transitory, tangible, machine readable media that include executable code that when run by one or more processors may cause the one or more processors to perform the processes of methods as described above. Some common forms of machine readable media that may include the processes of methods are, for example, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

Although illustrative examples have been shown and described, a wide range of modification, change and substitution is contemplated in the foregoing disclosure and in some instances, some features of the examples may be employed without a corresponding use of other features. One of ordinary skill in the art would recognize many variations, alternatives, and modifications. Thus, the scope of the disclosure should be limited only by the following claims, and it is appropriate that the claims be construed broadly and in a manner consistent with the scope of the examples disclosed herein.

1. A radio network comprising:
a baseband unit;
a fronthaul multiplexer coupled to the baseband unit;
a plurality of radio units, each one of the RUs being in communication with the baseband unit through the fronthaul multiplexer; and
a control loop configured to detect performance parameters of the plurality of RUs, including a Service and Management Orchestrator (SMO), which is configured to receive either the performance parameters or analysis of the performance parameters and to adjust a multiplexing functionality of the fronthaul multiplexer during use of the radio network and in near real time based, at least in part, on either the performance parameters or the analysis of the performance parameters.

2. The radio network of claim 1, wherein an artificial intelligence (AI) or machine learning (ML) application and is configured to be trained using the performance parameters and further configured to adjust the multiplexing functionality.

3. The radio network of claim 2, further comprising a near real time Radio Access Network (RAN) Intelligent Controller (RIC), wherein the AI or ML application is configured to adjust the multiplexing functionality by sending control signals to the near real time RIC to cause the near real time RIC to programmatically adjust operation of the fronthaul multiplexer.

4. The radio network of claim 3, further comprising a Non-Real-Time RIC, wherein the Non-Real-Time RIC is configured to collect the performance parameters of the plurality of RUs, further wherein the Non-Real-Time RIC implements an analytics module in software or firmware, wherein the analytics module is operable to analyze the performance parameters and send analysis of the performance parameters to the AI or ML application.

5. The radio network of claim 4, wherein the SMO is configured to train the AI or ML application by inputting multiple parameters of network operation to the AI or ML application, the multiple parameters of network operation including at least one item selected from a list consisting of: packet drops, jitter delay, radio unit availability, unsuccessful calls, and throughput.

6. The radio network of claim 2, wherein the AI or ML application is configured to adjust the multiplexing functionality by causing the fronthaul multiplexer to implement a greater number of cells within the plurality of RUs or to implement a smaller number of cells within the plurality of RUs.

7. The radio network of claim 6, wherein the AI or ML application is configured to adjust the multiplexing functionality on a radio unit-by-radio unit basis.

8. The radio network of claim 7, wherein the AI or ML application is configured to adjust the multiplexing functionality on a per-slice basis or on a per-service basis.

9. The radio network of claim 7, wherein the AI or ML application is configured to adjust the multiplexing functionality based at least in part on spectrum supported by individual ones of the RUs.

10. A method of using a feedback loop to control performance of a Radio Access Network (RAN), the method comprising:
gathering experience data at a component that is upstream from a baseband unit, wherein the experience data relates to performance parameters of the RAN;
analyzing the experience data; and
sending control signals to a fronthaul multiplexer, wherein the control signals are configured to adjust one or more multiplexing groups during use of the RAN and in near real time based, at least in part, on analyzing the experience data.

11. The method of claim 10, wherein the component that is upstream from the baseband unit comprises a software module that is included within a Service and Management Orchestrator (SMO).

12. The method of claim 10, wherein the component that is upstream from the baseband unit comprises a software module that is separate from a Service and Management Orchestrator (SMO).

13. The method of claim 10, wherein analyzing the experience data is performed by an artificial intelligence (AI) or machine learning (ML) application, which is included within a Service and Management Orchestrator (SMO).

14. The method of claim 13, further comprising:
training the AI or ML application based on further experience data.

15. The method of claim 10, wherein analyzing the experience data is performed by an artificial intelligence (AI) or machine learning (ML) application, wherein the method further comprises:
instructing a near real time Radio Access Network (RAN) Intelligent Controller (RIC), by the AI or ML application, to cause the near real time RIC to programmatically adjust operation of the fronthaul multiplexer.

16. The method of claim 10, wherein the performance parameters of the RAN include at least one item selected from a list consisting of: packet drops, jitter delay, radio unit availability, unsuccessful calls, and throughput.

17. The method of claim 10, wherein the control signals are sent to the fronthaul multiplexor as part of a manual adjustment of the fronthaul multiplexer.

18. A non-transitory computer readable medium including computer-executable code, which when executed by one or more computer processors, causes the one or more computer processors to perform a method of using a feedback loop to control performance of a Radio Access Network (RAN), wherein the computer readable medium comprises:
code for gathering experience data at a component that is upstream from a baseband unit, wherein the experience data relates to performance parameters of the RAN;
code for analyzing the experience data; and
code for sending control signals to a fronthaul multiplexer, wherein the control signals are configured to adjust one or more multiplexing groups during use of the RAN and in near real time based, at least in part, on analyzing the experience data.

19. The computer readable medium of claim 18, wherein the computer-executable code comprises an artificial intelligence (AI) or machine learning (ML) application, wherein the computer readable medium further comprises:
code for training the AI or ML application based on further experience data.

20. The computer readable medium of claim 19, further comprising:
code for instructing a near real time Radio Access Network (RAN) Intelligent Controller (RIC), by the AI or ML application, to cause the near real time RIC to programmatically adjust operation of the fronthaul multiplexer.

21. The computer readable medium of claim 18, wherein the code for sending control signals to the fronthaul multiplexer comprises code for adjusting the multiplexing functionality of the fronthaul multiplexer on a radio unit-by-radio unit basis.
